(19) United States
(12) Patent Application Publication
(10) Pub. No.: US 2006/0240860 A1
(43) Pub. Date: Oct. 26, 2006

(54) Network support for blocked dialing at vehicular high speed

(76) Inventors: David S. Benco, Winfield, IL (US); Sanjeev Mahajan, Naperville (IL); Baoling S. Sheen, Naperville, IL (US); Sandra L. True, St. Charles, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/113,869

(22) Filed: Apr. 25, 2005

(51) Int. Cl. H04M 1/00; H04Q 7/20

(52) U.S. Cl. 455/550.1; 455/441

(57) ABSTRACT

An apparatus in one example has: a mobile terminal, the mobile terminal having a GPS (Global Positioning System) unit and a dialing disable unit; a GPS module in a wireless telecommunications network having an input to receive GPS location data from the mobile terminal; a blocking module operatively coupled to the GPS module; and the blocking module having an output that provides a dialing disable/enable signal to the dialing disable unit in the mobile terminal as a function of the received GPS data.

### TECHNICAL FIELD

The invention relates generally to telecommunication networks, and more particularly to a telecommunication network that disables a dialing capability of a mobile terminal when a speed of the mobile terminal exceeds a predetermined threshold.

### BACKGROUND

GPS (Global Positioning System) is a satellite navigation system used to determine ground position and velocity (location, speed, and direction). Though it was created and originally used by the U.S. military, GPS is now available to the general public all over the world. GPS navigation systems are currently installed in a number of luxury cars, complete with an LCD map that shows the driver exactly where in the world he is. GPS navigation systems are also now available in cell phones so that the cell phones can be tracked.

There is widespread evidence that the major source of driver distraction pertaining to mobile phones can be attributed to dialing. First of all, normally two hands are required (one to grasp the phone, the other to enter the dialed digits), and secondly, the driver's visual attention is directed to the keypad to make sure the correct digits are entered. Once the call is set up, only one hand is required to hold the phone, and the driver's visual attention is again focused on the roadway. Answering an incoming call requires only one quick glance to hit the right button before the driver's attention again reverts to the roadway.

Even in view of the advances in the art of cellular telecommunications, there is still a drawback in the prior art regarding the use of cell phones and the possibility of serious dialing-related traffic accidents.

### SUMMARY

The invention in one implementation encompasses an apparatus. The apparatus may comprise a mobile terminal, the mobile terminal having a GPS (Global Positioning System) unit and a dialing disable unit; a GPS module in a wireless telecommunications network having an input to receive GPS location data from the mobile terminal; a blocking module operatively coupled to the GPS module; and the blocking module having an output that provides a dialing disable/enable signal to the dialing disable unit in the mobile terminal as a function of the received GPS data.

The invention in another implementation encompasses a method. This method may comprise: using GPS location data to calculate an average speed during the interval of a moving mobile terminal; and disabling a dialing capability of the mobile terminal when a speed of the mobile terminal exceeds a predetermined threshold.

Another implementation of the invention encompasses a method. This method may comprise: transmitting GPS location data from a mobile terminal to a telecommunications network; calculating a speed of the mobile terminal based on received GPS location data from the mobile terminal; comparing the calculated speed to a threshold; and disabling a dialing capability of the mobile terminal when the calculated speed exceeds the threshold, and enabling the dialing capability of the mobile terminal when the calculated speed is reduced below the threshold.

### DESCRIPTION OF THE DRAWINGS

Features of exemplary implementations of the invention will become apparent from the description, the claims, and the accompanying drawings in which:

FIG. 1 is a representation of one implementation of an apparatus that uses GPS location data to calculate an average speed during an interval of a moving mobile terminal; and disabling a dialing capability of the mobile terminal when a speed of the mobile terminal exceeds a predetermined threshold;

FIG. 2 is a representation of one exemplary flow diagram for disabling a dialing capability of a mobile terminal when the mobile terminal is traveling at a high rate of speed; and

FIG. 3 is a representation of another exemplary flow diagram for disabling a dialing capability of a mobile terminal when the mobile terminal is traveling at a high rate of speed.

### DETAILED DESCRIPTION

Embodiments of the present apparatus and method reduce the possibility of serious dialing-related accidents by disabling the dialing capability of the mobile terminal when the mobile terminal's linear speed exceeds a threshold (e.g., 55 mph). The linear speed is calculated from mobile-transmitted GPS data.

Methodologies of the present apparatus and method involve a telecommunications network to receive GPS location data that is transmitted from a moving mobile terminal. The network uses the GPS location data to calculate an average speed during the interval of the mobile terminal. The more frequently the GPS location data is transmitted, the more closely the calculated average speed reflects the actual instantaneous speed.

When a speed of the mobile terminal exceeds a threshold a message is sent from the network to the mobile terminal that disables the dialing capability of the handset. When the speed of the mobile terminal is reduced below the threshold a message is sent from the network to the mobile terminal that enables the dialing capability of the handset.

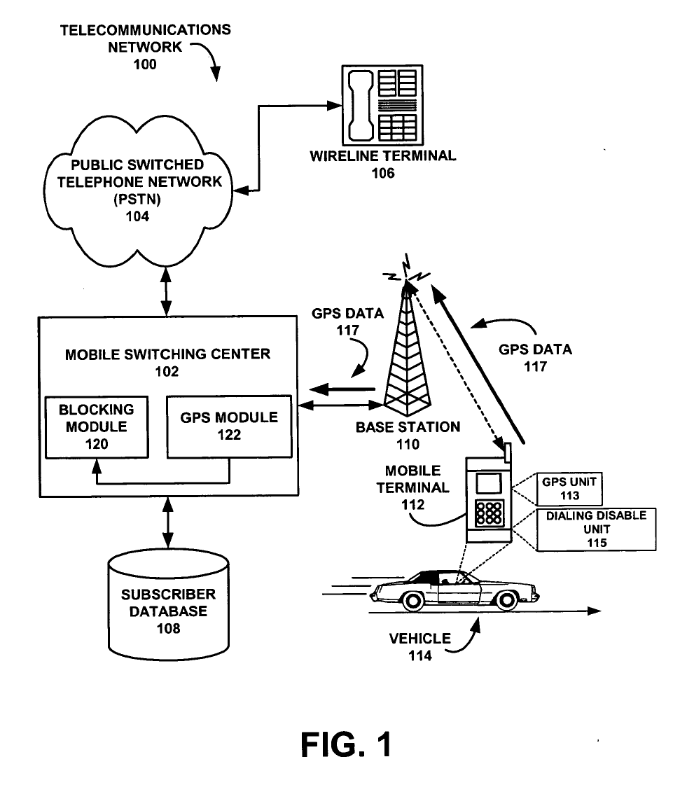

FIG. 1 is a representation of one implementation of an apparatus that provides for disabling the dialing capability of the mobile terminal when the mobile terminal's linear speed exceeds a threshold.

A telecommunications network 100 may have a mobile switching center (MSC) 102. The network 100 may be, or may be part of, one or more of a telephone network, a local area network (“LAN”), the Internet, and a wireless network. In the depicted embodiment, a public switched telephone network (PSTN) 104 may be connected to the MSC 102. The PSTN 104 may, for example, route calls to and from a mobile terminal 112 through the MSC 102, and to a wireline terminal 106. The MSC 102 may also be connected to at least one base station (BS) 110. The base station 110 may communicate with the mobile terminal 112 in its service area using a subscriber database 108.

The PSTN 104 generally may be implemented as the worldwide voice telephone network accessible to all those with telephones and access privileges (e.g., AT&T long distance network). The mobile terminal 112 may be any one of a number of devices, such as a cell phone, a personal data assistant (PDA), a laptop computer, etc. In the FIG. 1 embodiment the mobile terminal 112 is equipped with a GPS unit 113 and a dialing disable unit 115. The dialing disable unit 115 may be used to disable the dialing capability of the mobile terminal. It may also cause a safety message to be displayed on a screen of the mobile terminal 115.

As depicted in FIG. 1 the mobile terminal 112 is in a moving vehicle 114. The GPS unit 115 in the mobile terminal may send GPS location data 117 to the MSC 102 via the base station 110. In the MSC 102 a GPS module 122 receives the GPS data 117, calculates the speed of the mobile terminal 112, and compares the speed with a threshold. The GPS module 122 may be operatively coupled to a blocking module 120 that sends a message to the mobile terminal 112 that causes the dialing disable unit 115 to disable the dialing capability of the mobile terminal when a speed of the mobile terminal exceeds a first predetermined threshold. Also, the blocking module 120 may send a message to the mobile terminal 112 that causes the dialing disable unit 115 to enable the dialing capability of the mobile terminal when a speed of the mobile terminal is reduced below a second predetermined threshold. In one embodiment the first and second thresholds may be equal. In other embodiments the first and second thresholds may not be equal.

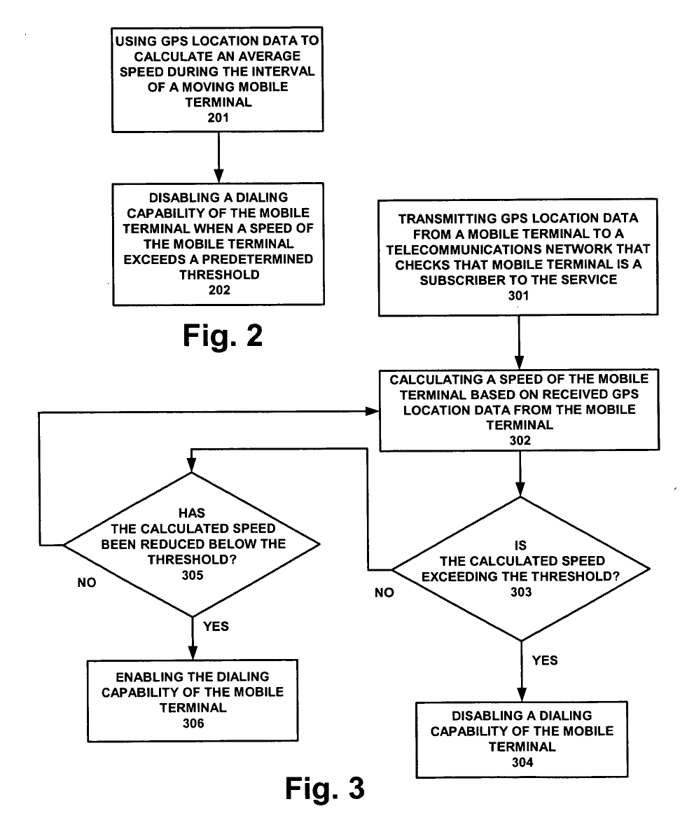

FIG. 2 is a representation of one exemplary flow diagram of the present method. It is to be understood that initially the network checks that the mobile terminal is a subscriber to the service. Such information may be stored in the subscriber database. The method may have the steps of: using GPS location data to calculate an average speed during the interval of a moving mobile terminal (201); and disabling a dialing capability of the mobile terminal when a speed of the mobile terminal exceeds a predetermined threshold (202).

FIG. 3 is a representation of one exemplary flow diagram of the present method. This method may have the steps of: transmitting GPS location data from a mobile terminal to a telecommunications network (301); calculating a speed of the mobile terminal based on received GPS location data from the mobile terminal (302); comparing the calculated speed to a threshold (303); and disabling a dialing capability of the mobile terminal when the calculated speed exceeds the threshold (304), and enabling the dialing capability of the mobile terminal when the calculated speed is reduced below the threshold (305).

Embodiments of the present apparatus and method overcomes the drawbacks of the prior art by using GPS location data to calculate an average speed during an interval of a moving mobile terminal, and disabling a dialing capability of the mobile terminal when a speed of the mobile terminal exceeds a predetermined threshold.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. Examples of a computer-readable signal-bearing medium for the apparatus 100 may comprise the recordable data storage medium (subscriber database 108). The computer-readable signal-bearing medium for the apparatus 100 in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a mobile terminal, the mobile terminal having a GPS (Global Positioning System) unit and a dialing disable unit;
a GPS module in a wireless telecommunications network having an input to receive GPS location data from the mobile terminal;
a blocking module operatively coupled to the GPS module; and
the blocking module having an output that provides a dialing disable/enable signal to the dialing disable unit in the mobile terminal as a function of the received GPS data.

2. The apparatus according to claim 1, wherein the blocking module, via the dialing disable unit in the mobile terminal, disables a dialing capability of the mobile terminal when a velocity of the mobile terminal exceeds a first predetermined threshold.

3. The apparatus according to claim 2, wherein the blocking module, via the dialing disable unit in the mobile terminal, enables a dialing capability of the mobile terminal when a velocity of the mobile terminal is less than a second predetermined threshold.

4. The apparatus according to claim 1, wherein the first predetermined threshold is equal to the second predetermined threshold.

5. The apparatus according to in claim 1, wherein the GPS module calculates a speed of the mobile terminal from the received GPS location data.

6. The apparatus according to claim 1, wherein a safety message is displayed on a screen of the mobile terminal when the dialing capability is disabled.

7. The apparatus according to claim 1, wherein the mobile terminal is conveyed in a moving vehicle.

8. The apparatus according to claim 1, wherein the GPS location data is used to calculate the mobile user's average speed during an interval.

9. A method comprising:
using GPS (Global Positioning System) location data to calculate an average speed during the interval of a moving mobile terminal; and
disabling a dialing capability of the mobile terminal when a speed of the mobile terminal exceeds a predetermined threshold.

10. The method according to claim 9, wherein the method further comprises:
transmitting the GPS location data from the mobile terminal to a telecommunications network; and
disabling the dialing capability of the mobile terminal when the calculated speed exceeds the threshold, and enabling the dialing capability of the mobile terminal when the calculated speed is reduced below the threshold.

11. The method according to claim 10, wherein the dialing capability of the mobile terminal is disabled when the speed of the mobile terminal exceeds a first predetermined threshold, and the dialing capability of the mobile terminal is enabled when the calculated speed of the mobile terminal is less than a second predetermined threshold.

12. The apparatus according to claim 9, wherein a safety message is displayed on a screen of the mobile terminal when the dialing capability is disabled.

13. The apparatus according to claim 9, wherein the mobile terminal is conveyed in a moving vehicle.

14. A method comprising:
transmitting GPS (Global Positioning System) location data from a mobile terminal to a telecommunications network;
calculating a speed of the mobile terminal based on received GPS location data from the mobile terminal;
comparing the calculated speed to a threshold; and
disabling a dialing capability of the mobile terminal when the calculated speed exceeds the threshold, and enabling the dialing capability of the mobile terminal when the calculated speed is reduced below the threshold.

15. The method according to claim 14, wherein the dialing capability of the mobile terminal is disabled when a speed of the mobile terminal exceeds a first predetermined threshold.

16. The method according to claim 15, wherein the dialing capability of the mobile terminal is enabled when a speed of the mobile terminal is less than a second predetermined threshold.

17. The method according to claim 16, wherein the first predetermined threshold is equal to the second predetermined threshold.

18. The method according to claim 14, wherein the method further comprises displaying a safety message on a screen of the mobile terminal when the dialing capability is disabled.

19. The method according to claim 14, wherein the mobile terminal is conveyed in a moving vehicle.

20. The method according to claim 14, wherein the method further comprises calculating an average speed of the mobile terminal from the GPS location data during an interval.
